(19) United States
(12) Patent Application Publication
(10) Pub. No.: US 2007/0101332 A1
(43) Pub. Date: May 3, 2007

(54) METHOD AND APPARATUS FOR RESOURCE-BASED THREAD ALLOCATION IN A MULTIPROCESSOR COMPUTER SYSTEM

(75) Inventors: Adam Joseph Courchesne, Belchertown, MA (US); Francis A. Kampf, Jeffersonville, VT (US); Gregory John Mann, Wheaton, IL (US); Jason Michael Norman, Essex Junction, VT (US); Stanley B. Stanski, Essex Junction, VT (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 11/163,746

(22) Filed: Oct. 28, 2005

(51) Int. Cl. G06F 9/46

(52) U.S. Cl. 718/102

(57) ABSTRACT

Thread entries are stored in a memory of the system to indicate executed instruction threads. Uses of processing resources by the respective instruction threads are detected and history entries for the threads are stored in a memory of the system. Such history entries indicate whether respective processing resources have been used by respective ones of the instruction threads. The history entries of first and second ones of the instruction threads are compared. The second instruction thread is selected for executing if the comparing indicates history of processing resources used by the first thread has a certain difference relative to history of processing resources used by the second thread.

### BACKGROUND

1. Field of the Invention

The present invention concerns multithreaded computer systems, and more particularly determining conflicts among threads in such systems.

2. Related Art

A conventional two-processor, system on a chip is shown in FIG. 1. In this system 100, processors 102 and 104 share a processor local-bus (“PLB”) 106 interconnected to an on-chip peripheral bus (“OPB”) 108 by a bridge 110 and memory controller 112 which is interconnected to random access memory (“RAM”) 116 and a DMA peripheral device 118. System 100 includes a number of peripheral devices (including peripheral adapters that are not shown) usb30, SATA, audio DAC, audio ADC, LCD, MAL, wireless, uART, crypto, camera, mpeg enc, mpeg dec and DMA, coupled to OPB 106, as shown. In a multiple processor environment such as this, multiple threads run literally at the same time and thus may compete to use the same peripheral devices. This, of course, gives rise to a potential for conflict among threads. Aspects of this problem have been dealt with in the prior art. For example, in U.S. Pat. No. 6,018,759, a thread switch tuning tool is provided that uses a time out process to adjust the amount of time threads run. In another example, U.S. Pat. No. 6,061,710 deals with handling hardware interrupts in the multithread context.

### SUMMARY OF THE INVENTION

The present invention addresses the above described problem. In one form of the invention, an apparatus includes processors operable to concurrently execute respective instruction threads, wherein the system includes circuitry operable to communicate with the processors, and the system is operable to access shared processing resources. The circuitry includes memories for respective instruction threads and first logic circuitry operable to generate and store history entries for the processing resources in the memories for the respective instruction threads. Such a history entry indicates whether the processing resource for that entry has been used by the memory's corresponding one of the instruction threads. Second logic circuitry is operable to compare the history entries of first and second ones of the instruction threads. The second logic circuitry is also operable to select the second instruction thread for executing if the comparing indicates history of processing resources used by the first thread has a certain difference relative to history of processing resources used by the second thread.

In another aspect, the first logic circuitry includes first sub-logic circuitry operable to generate and store if-used history entries in the memories. The first sub-logic circuitry sets such an if-used entry to indicate whether a corresponding one of the processing resources has been used by a corresponding one of the instruction threads and resets the if-used entry in response to the corresponding instruction thread exceeding a certain threshold of accumulated non-use of the corresponding processing resource.

In another aspect, the first logic circuitry includes second sub-logic circuitry operable to generate and store when-used history entries in the memories. The when-used history entries indicate when the respective processing resources were last used by the respective threads.

In a method form of the invention, thread entries are stored in a first memory to indicate executed instruction threads. Uses of processing resources by the respective instruction threads are detected and history entries for the threads are stored in a second memory. Such history entries indicate whether respective processing resources have been used by respective ones of the instruction threads. The history entries of first and second ones of the instruction threads are compared. The second instruction thread is selected for executing if the comparing indicates history of processing resources used by the first thread has a certain difference relative to history of processing resources used by the second thread.

In another aspect, the certain difference between the history of processing resources used by the first thread and the history of processing resources used by the second thread includes the history of processing resources used by the first thread being entirely different than the history of processing resources used by the second thread.

In one alternative, the first thread is running and one of the system processors has selected the second thread as a candidate to run with the first thread.

In another alternative, one of the system processors has selected the first thread to run and the second thread is already running.

In another aspect, the processing resources include peripheral devices of the system.

Other variations, objects, advantages, and forms of the invention will become apparent upon reading the following detailed description and upon reference to the accompanying drawings.

### DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment read in conjunction with the accompanying drawings.

FIG. 1 illustrates a conventional two processor system on a chip, according to the prior art.

FIG. 2 illustrates a system on a chip, according to an embodiment of the present invention.

FIG. 3 is a high-level block diagram illustrating certain processes and structures for a candidate thread query that determines if a specific thread conflicts with threads that are running at a particular time, according to an embodiment of the present invention.

FIG. 4 is a high-level block diagram illustrating certain processes and structures for a query that determines threads available to run with a starved thread, according to an embodiment of the present invention.

FIG. 5 is a block diagram illustrating certain aspects of thread resource allocation logic, according to an embodiment of the present invention.

FIG. 6 illustrates details of the thread resource allocation logic of memory array for tracking which peripheral resources are used and which threads use them, according to an embodiment of the present invention.

FIG. 7, is a flow chart illustrating certain general aspects about how thread resource allocation logic determines if a specific thread can be run with other threads that are already running at a particular time, according to an embodiment of the present invention.

FIG. 8 illustrates thread resource allocation logic for determining threads available to run with a starved thread, according to an embodiment of the present invention.

FIG. 9 illustrates thread resource allocation logic for determining if a specific thread can be run with other threads that are already running at a particular time, according to an embodiment of the present invention.

### DETAILED DESCRIPTION OF A PREFERRED EMBODIMENT OF THE INVENTION

In the following detailed description of the preferred embodiments, reference is made to the accompanying drawings illustrating embodiments in which the invention may be practiced. It should be understood that other embodiments may be utilized and changes may be made without departing from the scope of the present invention. The drawings and detailed description are not intended to limit the invention to the particular form disclosed. On the contrary, the intention is to cover all modifications, equivalents and alternatives falling within the spirit and scope of the present invention as defined by the appended claims. Headings herein are not intended to limit the subject matter in any way.

System

As previously stated, in a multiple processor environment, multiple threads run literally at the same time and thus may compete to use the same peripheral devices. According to an embodiment of the present invention, thread resource allocation logic (also referred to herein as a “thread resource allocation core,” or “TRAC”) determines thread combinations that can be run at a particular time to reduce thread conflicts. This may include the TRAC responding to a specific thread query from a processor, wherein the processor indicates a specific thread as a candidate for a context switch and the TRAC responds by indicating whether the thread will cause resource conflicts. In addition, or alternatively, this may include the TRAC responding to a starved thread query from a processor, wherein the TRAC determines and communicates to the processors one or more list of threads that will not cause resource conflicts with a given thread, e.g., a “starved” thread that needs to be run.

The TRAC includes logic and a memory array (referred to herein as a “resource usage memory,” “resource usage list” or “RUL”) to track which peripheral resources are used and which threads use them. The RUL has memory entries indicating which peripherals have been used by each thread, and entries indicating when each thread used each one of those peripherals.

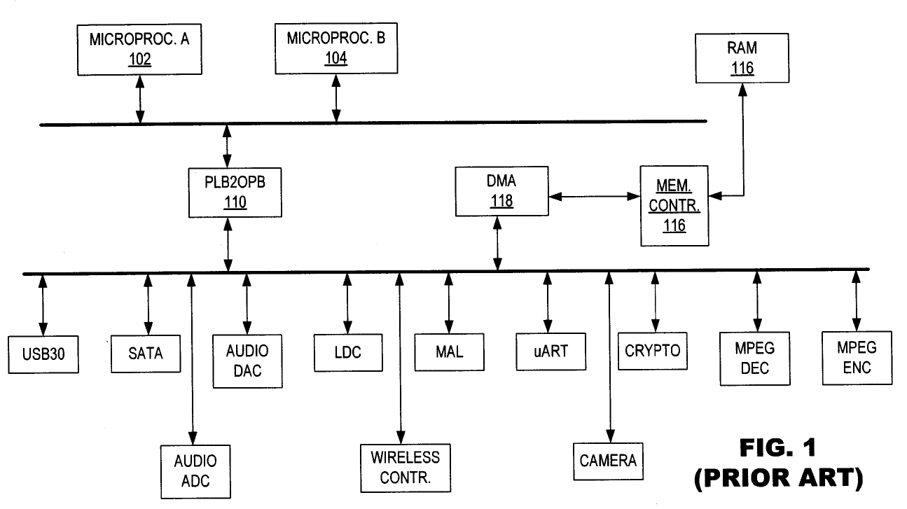

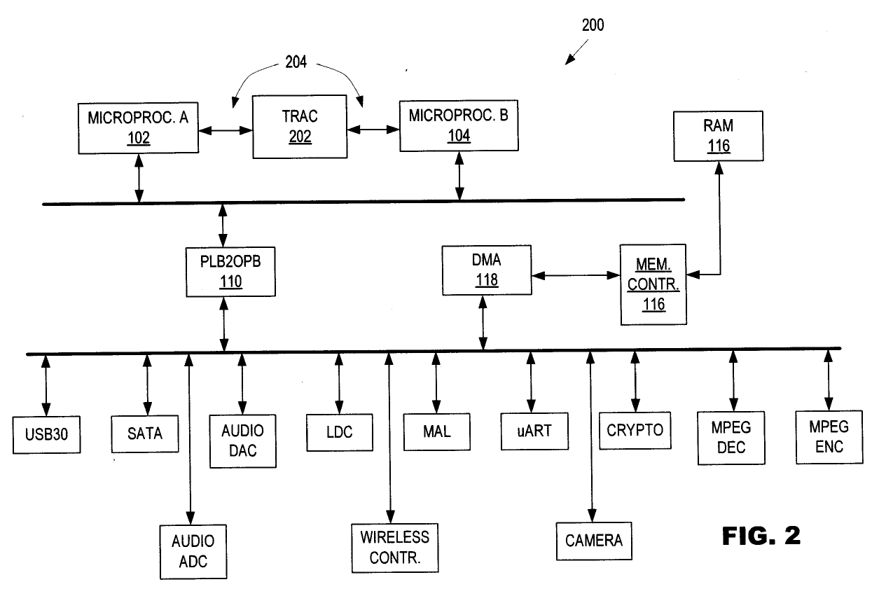

Referring now to FIG. 2, a system on a chip 200 is illustrated, according to an embodiment of the present invention. In system 200, like system 100 of FIG. 1, processors 102 and 104 share PLB interconnect bus 106, which is further connected to OPB bus 108 bridge 110 and memory controller 112. (Of course, the present invention is applicable to systems having more than two processors. An increased number of processors increases peripheral conflicts. So the present invention is all the more useful in systems with more processors.) OPB 108 of FIG. 2 has an associated OPB clock 120 and operates according to cycles thereof. System 200, like system 100, includes a number of peripheral devices (connected to OPB 108 by peripheral adapters that are not shown) usb30, SATA, audio DAC, audio ADC, LCD, MAL, wireless, uART, crypto, camera, mpeg enc, mpeg dec and DMA, as shown.

In addition to the features of conventional system 100, system 200 includes TRAC 202, which is connected to PLB 106 such that it can snoop transactions on the bus. Processor 102 and 104 can access DCR registers (not shown in FIG. 2) of TRAC 202 via a DCR bus 204. The DCR registers contain status information for threads and peripheral resources including usb30, SATA, audio DAC, etc. shown in FIG. 2. The DCR registers indicate thread combinations that processors 102 and 104 can run at a particular time.

Conceptual Block Diagrams for Determining Thread Combinations

Candidate Thread Query

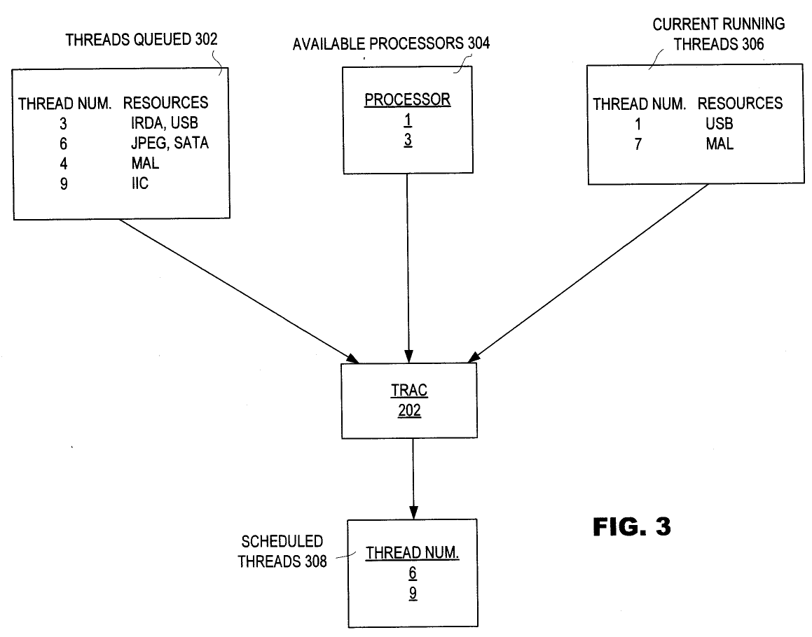

Referring now to FIG. 3, a block diagram is shown illustrating certain processes and structures for a candidate thread query that determines if a specific thread can be run at a particular time, according to an embodiment of the present invention. TRAC 202 is shown responding to a query, referred to in FIG. 3 as “threads queued” 302. That is, “available processors” 304 indicates to TRAC 202 specific threads as candidates for context switches. In the illustrated instance, processors 102 and 104 of FIG. 2 are available and the candidate threads of the query 302 are threads 3, 6, 4 and 9. Each of these threads 3, 6, 4 and 9 are each associated with certain peripheral resources shown in FIG. 2 in a manner that will be explained further herein below. Specifically, thread 3 is associated with IrDA and USB; thread 6 is associated with JPEG and SATA; thread 4 is associated with MAL; and thread 9 is associated with IIC as shown in threads queried 302.

TRAC 202 includes logic and a memory array (not shown in FIG. 3) to track which of the peripheral resources are used and which threads use them. This includes memory entries (not shown) indicating which of the peripherals usb30, SATA, audioDAC, etc. of FIG. 2 have been used by each thread, and entries indicating when each thread used each one of those peripherals. Thus, as shown, TRAC 202 monitors “currently running threads” 306 via OPB 108 (FIG. 2). In the illustrated instance, threads 1 and 7 are running. Thread 1 is using USB and thread 7 is using MAL. TRAC 202 responds to the specific query 302 by indicating which ones of the candidate threads 3, 6, 4 and 9 can run, i.e., which ones will not cause resource conflicts with the currently running threads 1 and 7, and, by implication, which threads will cause conflicts with threads 1 and 7. In the example shown, TRAC 202 indicates threads 6 and 9 can run, i.e., they will not cause conflicts, as shown, “scheduled threads” 308.

Starved Thread Query

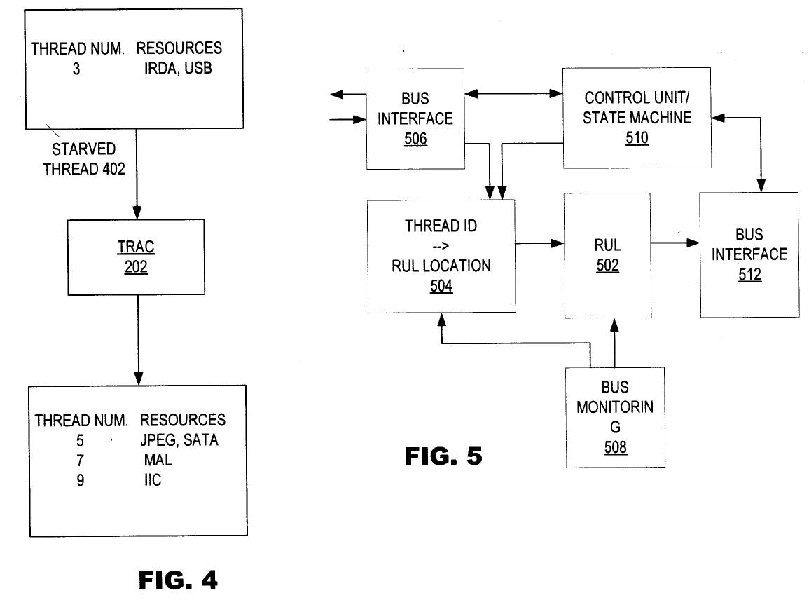

Referring now to FIG. 4, a block diagram is shown illustrating certain processes and structures for a query that determines threads available to run with a starved thread, according to an embodiment of the present invention. TRAC 202 is shown responding to a query from a processor, referred to in FIG. 4 as “starved thread” 402. That is, a processor 102 or 104 indicates a specific thread, for TRAC 202 to determine threads that can run with the starved thread without peripheral resource conflict. In the illustrated instance, the starved thread of the query is thread number 3. TRAC 202 associates this thread with certain peripheral resources shown in FIG. 4 in a manner that will be explained further herein below. Specifically, thread 3 is associated with IrDA and USB.

TRAC 202 responds to the starved thread query 402 by indicating which ones of the existing threads can run, i.e., regardless of whether they are currently running, which ones will not cause resource conflicts, and, by implication, which threads will cause conflicts. In the example shown, threads 5, 7 and 9 can run, i.e., they will not cause conflicts, since thread 5 is associated with peripheral MAL, thread 7 is associated with IIC and thread 9 is associated with JPEG and SATA, which are all different than the peripherals associated with thread 3.

TRAC 202 writes the identified non-conflicting threads to an allocated memory array as a list 404 of the threads” process identifiers having a “00” at the end of the list. Of course, a different terminating symbol may be used.

Block Diagram for TRAC

Referring now to FIG. 5, a high-level block diagram is shown illustrating certain aspects of TRAC 202, according to an embodiment of the present invention. TRAC 202 includes RUL 502 coupled to RUL thread assignment logic 504, which, in turn, is coupled to DCR bus interface 506 (FIG. 2). TRAC 202 further includes bus monitoring logic 508 coupled to PLB 106 (FIG. 2) that functions to snoop for accesses by threads of processor 102 and 104 (FIG. 2) to peripherals on OPB 108 (FIG. 2). That is, bus monitoring logic 508 snoops PLB 106 (FIG. 2) to determine the identity of threads as they are executed by processor 102 and 104 (FIG. 2) and to determine the identity of peripherals usb30, SATA, etc. (FIG. 2) that particular threads are accessing. Thus, by snooping PLB 106, TRAC 202 continually keeps track of which threads are using which peripherals.

More specifically, the operating system on system 200 assigns which threads run on which processor 102 and 104 and signals these thread assignments to bus interface unit 506. Control unit 510 obtains this information from bus interface unit 506. TRAC 202 includes thread-processor map registers (not shown), into which control unit 510 writes entries for each thread, including a thread process identifier and an identifier for the associated processor 102 or 104 of the thread. This provides a thread-to-processor map.

Bus monitoring logic 508 also writes entries in registers (not shown) for the respective peripherals usb30, SATA, etc., indicating the addresses by which processors 102 and 104 access the peripherals. This provides an address-to-peripheral map.

During operation of system 200, bus monitoring logic 508 monitors transactions for threads on PLB 106 and determines the targeted peripheral usb30, SATA, audio DAC, etc. of such a transaction through reference to the address-to-peripheral map. Bus monitoring logic 508 is operatively coupled to thread assignment logic 504, which, in turn, is coupled to RUL 502. Bus monitoring logic 508 communicates the peripheral use to thread assignment logic 504, which writes to thread entries therein, providing a record in RUL 502 of which threads are using which peripherals, as further described herein below.

Control logic 510 receives candidate thread and starved thread queries from processors 102 and 104 (FIG. 2) via DCR bus interface 506 and responsively passes process identifiers for the threads of the queries to conflict logic 512. Control logic 510 of TRAC 202 is coupled to conflict logic 512 and DCR bus interface 506 (FIG. 2). Conflict logic 512 is also coupled to RUL 502 and is operable to read RUL 502 entries to determine, for a thread of a given query, what other threads do and do not have peripheral conflicts with the thread. Conflict logic 512 returns replies to control logic 510, and, in turn, control logic 510 replies to processors 102 and 104 via DCR bus interface 506.

More specifically, in a query to TRAC 202, a processor 102 or 104 includes a process identifier for a thread and query type, indicating whether the query is asking i) whether the identified thread conflicts with currently running threads (referred to herein as a “candidate thread” query), or ii) what threads exist that do not conflict with the identified thread (referred to herein as a “starved thread” query). The process identifier and query type are written in a DCR query register (not shown) by control logic 510 and then conflict logic 512 performs a particular comparison or series of comparisons, as specified by the query type, between the identified thread in the DCR query register and threads in RUL 502, as will be further described herein below.

RUL

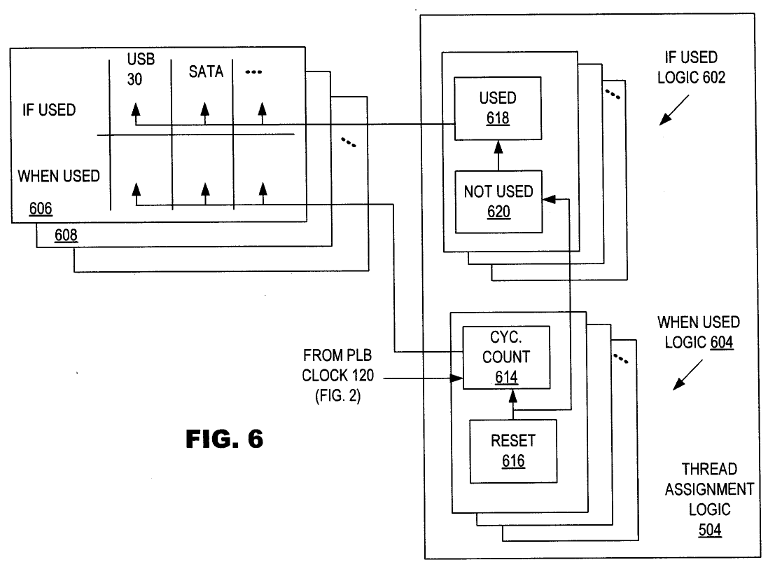

Referring now to FIG. 6, RUL 502 and associated “if used” logic 602 and “when used” logic 604 of thread assignment logic 504 are shown for tracking which peripheral resources are used, when they are used, and which threads use them, according to an embodiment of the present invention. RUL 502 includes a number of thread arrays, i.e., a first array 606 for the first thread, a second array 608 for the second thread, etc., shown figuratively stacked one on top of the other for the sake of illustration. Each thread array is similar in structure to thread array 606 figuratively shown on the top in FIG. 6.

Thread array 606 has columns for each of the peripheral resources of FIG. 2, an “if used” row 610 (which may be a register) having a memory entry in each column indicating whether the peripheral resource of the respective column was used in the past by the thread associated with thread array 606, and a “when used” row 612 (which may also be a register) with a memory entry in each column indicating when the peripheral resource of the respective column was used in the past by the associated thread. (It should be understood that each row of RUL 502 may be a register and each column may be a bit in that register. The entries in the columns of the “if used” row for a thread may thus be referred to herein as the “used” bits.)

It should be understood that in other embodiments of the invention there are arrangements other than described above. In one other embodiment, instead of TRAC 202 using both the “if used” row 610 and “when used” row 612 of thread array 606 (and the others, such as array 608, like it), TRAC 202 uses simply the “when used” row 612 to determine both if a peripheral has been used and when it was used.

Alternative Ways to Generate and Remove Entries for RUL

In the embodiment of the present invention shown in FIG. 6, an entry is generated for the “when used” row 610 of a thread array, such as array 606, by “when used” logic 604 that is responsive to a cycle counter. In the illustrated cycle-counter-based embodiment of the invention, logic 604 for the “when used” row 612 of thread array 606 includes PLB cycle counter logic 614. (Note that in FIG. 2, PLB 106 has an associated PLB clock 120 and operates according to cycles of that clock.) PLB cycle counter logic 614 for the thread associated with thread array 606 periodically enters accumulated counts of cycles of PLB clock 120 for each column of the “when used” row 612. (This may be done, for example, every cycle of PLB clock 120.) Reset logic 616 monitors PLB 106 for I/O accesses by respective processors 102 and 104 (FIG. 2) to peripherals usb30, etc. and signals to PLB cycle counter logic 614 to reset the count for such a column each time the thread accesses the peripheral resource associated with the column. Thus, the lower the count in row 612 of a column of thread array 606, the more recently the associated peripheral has been used.

Likewise, in the embodiment of the present invention, an entry is generated for the “if used” row 610 of thread array 606, by “if used” logic 602. “If used” logic 602 includes “used” logic 618 that receives the signals from reset logic 616 for accesses to peripherals and sets to a value of “1” a bit of the “if used ” row 610 in the respective one of the columns associated with a particular one of the peripherals usb30, etc. of FIG. 2 in response to the thread associated with array 606 accessing that peripheral. “If used” logic 602 resets the bit to a value of “0” responsive to the thread not accessing the peripheral again for more than a predetermined time interval. That is, in the illustrated embodiment of the invention, “if used ” logic 602 includes “not used” logic 620 that reads the accumulated counts of cycles of PLB clock 120 for the peripheral and signals to “used ” logic 618 to reset the bit to “0” in response to the accumulated count exceeding a predetermined threshold number.

In an alternative embodiment of the invention, instead of PLB cycle counter logic 614 “when used” logic 604 has thread access counter logic (not shown) for the thread associated with thread array 606. Thread access counter logic initially sets a column of the “when used” row 612 to a predetermined value in response to reset logic 616 signaling that the thread for the thread array 606 has accessed the peripheral of that column. Thread access counter logic also monitors PLB 106 to determine if the thread is paused. Responsive to the thread being paused without accessing a peripheral, thread access counter logic decrements the column of the “when used” row 612 for that peripheral. Further, responsive to the value of the column being decremented to “0”, thread access counter logic signals “used” logic 618 to reset “if used” row 610 for that column. Thus, for the alternative embodiment of the invention, the higher the accumulated count in “when used” row 612 of a column of thread array 606, the more recently the associated peripheral has been used.

Regarding the above described alternatives, the cycle-counter-based embodiment of the invention shown in FIG. 6 is advantageous in a situation where peripherals are transparent to the threads. For example, a direct memory access write to a storage device may not have interrupts enabled, which makes it complicated for a thread to know when a write to the device is complete. That is, unless the thread queries the device itself, TRAC 202 will not detect any indication that the write to the device is complete.

Example of TRAC Operation

Referring again to FIGS. 2 and 5, in an exemplary instance, system 200 is operating. Specifically, processor 102 is running the following:

thread 0 using USB30, crypto, and SATA;

thread 1 using wireless, MPEG decoder, LCD controller, and audio DAC;

thread 2 using MPEG encoder, MPEG decoder, audio adc, audio dac, lcd controller, camera and wireless controller;

thread 3 using SATA; and

thread 4 using USB30.

Processor 104 is running thread 5 using audio ADC.

As described herein above, the operating system knows which threads are running on which processors 102 and 104, which is communicated to TRAC 202 control unit 510 via bus interface 506. Bus monitoring logic 508 determines which peripheral a thread is using by detecting an I/O request by processor 102 or 104 to an I/O device at a particular address. Responsive to information from bus monitoring logic 508, thread assignment logic 504 assigns the sequence set out below to the peripherals and writes this assignment map to a register.

[0]: USB30

[1]: SATA

[2]: audio DAC

[3]: audio ADC

[4]: LCD

[5]: MAL

[6]: wireless

[7]: uART

[8]: crypto

[9]: camera

[10]: mpeg enc

[11]: mpeg dec

(DMA is not on the above list because it can be configured to handle multiple requests from multiple processors and, therefore, does not encounter conflicts.) For this situation, bus monitoring logic 508 monitors transactions for threads on PLB 106, refers to the address-to-peripheral map, and responsively determines that the above threads are using the above indicated peripherals. Monitoring logic 508 thus writes to “if used” rows for the respective threads such as row 610 of array 606 (FIG. 6). This provides a record in RUL 502 of which threads are using which peripherals as shown in Table 1 below.

TABLE 1
“Used” bits in RUL for Respective Threads

| | |
|---|---|
| Thread 0 | 110000001000 |
| Thread 1 | 001010100001 |
| Thread 2 | 001110100111 |
| Thread 3 | 010000000000 |
| Thread 4 | 100000000000 |
| Thread 5 | 000100000000 |

After some time, processor 102 times out and interrupts the operating system for a context switch. The operating system determines that it will switch both processors 102 and 104, and queries TRAC 202 for sets of threads that can run concurrently. Thus, one of processors 102 or 104 sends a query to control logic 510 of TRAC 202, which writes the query to a DCR register and notifies conflict logic 512 of the query. In response, conflict logic 512 performs a comparison or sequence of comparisons among entries in RUL 502, which determines four sets of threads having no conflicts. Conflict logic 512 writes the sets of non-conflicting threads in four DCR-readable registers, as set out in Table 2 below. (The number of registers corresponds to the number of different sets the TRAC can compute. In the illustrated embodiment, four sets of non-conflicting threads is the maximum that conflict logic can determine. In other embodiments of the invention this number may be different. More logic is required for determining more sets which tends to constrain the number of sets.)

TABLE 2

| | |
|---|---|
| Subset Peg 0 | 0000_0023 (Threads 0, 1, and 5) |
| Subset Peg 1 | 0000_001C (Threads 2, 3, and 4) |
| Subset Peg 2 | 0000_0032 (Threads 1, 4, and 5) |
| Subset Peg 3 | 0000_0038 (Threads 3, 4, and 5) |

It should be understood that the register values set out in Table 2 are shown in hexadecimal format. Thus, for example, 0000_{—}0023 represents the following thirty-two bits: 00000000000000000000000000100011, which has a logical “1” value for the first, second and fifth bits, representing the first, second and fifth threads. The register width is determined by the maximum number of threads TRAC 202 can track, which in the illustrated embodiment example is thirty two. Table 2 shows the status of these registers at the time of the context switch.

In this example, the operating system picks threads 2 and 3 to run on processors 102 and 104, respectively. The operating system notifies TRAC 502 of this selection via DCR bus 108 and thread assignment logic 504 responsively updates the thread-to-processor map.

After some additional time, one of the processors 102 or 104 times out again and interrupts the operating system to perform another context switch. The operating system determines that thread 1 must be scheduled, regardless of conflict possibilities. The operating system TRAC 202 of this selection via DCR bus 204 and control logic 510 sets a TRAC register to indicate subsets containing only thread 1. The register is as wide as the maximum number of threads TRAC 202 can manage, which, in the illustrated embodiment, is thirty two. Thus, the register is set to “0x0000_{—}0001.” Conflict logic 512 performs a “starved thread” comparison or sequence of comparisons among entries in RUL 502, which determines sets of threads than can run with thread 1 without conflict. Conflict logic 512 writes the sets of non-conflicting threads in four DCR-readable registers, as set out in Table 3 below.

TABLE 3

| | |
|---|---|
| Subset Peg 0 | 0000_0023 (Threads 0, 1 and 5) |
| Subset Peg 1 | 0000_0032 (Threads 1, 4 and 5) |
| Subset Peg 2 | 0000_0000 No Threads |
| Subset Peg 3 | 0000_0000 No Threads |

The operating system picks threads 4 to run with thread 1, notifies TRAC 202 of this selection via DCR bus 204, and thread assignment logic 504 responsively updates the thread-to-processor map once again.

Process for Determining if a Thread can be Run with Currently Running Threads

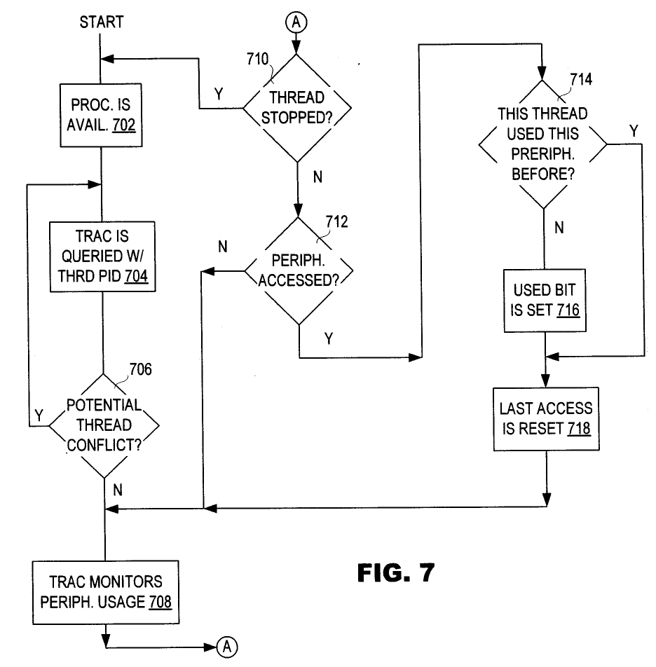

Referring now to FIG. 7, a flow chart is shown illustrating generally TRAC operation, according to an embodiment of the present invention. At 702, when a processor 102 or 104 is available to start a switch to a new thread, one of the processors 102 or 104 queries TRAC 202 at 704 to determine if a specific thread among candidate threads for the processor can be run with other threads that are already running. If no, then the processor selects a different candidate thread and repeats the query at 704, and so on until a thread is found at 706 that can be run.

When a thread is found to run, the processor runs the thread. At 708 TRAC 202 monitors to keep RUL 502 current regarding which threads use which peripherals. Specifically, this includes detecting at 710 for the thread to stop. While the thread continues this includes TRAC 202 snooping at 712 for a peripheral access by the thread. If an access is detected, then at 714 TRAC 202 checks the used bit to see if the peripheral accessed has been accessed before. If no, then at 716 TRAC 202 sets the peripheral's bit in RUL 502 for the thread, and TRAC 202 logic flow continues to 718. If yes, then at 716 the bit does not need to be set. Accordingly, TRAC 202 logic flow skips to 718, where TRAC resets the peripheral's “last used” bit for the thread to indicate the peripheral is the last one used. Then TRAC 202 logic flow returns to block 708 to continue monitoring.

At 710, when TRAC detects the thread stop, TRAC 202 logic flow branches to 702 and awaits a new query at 704 from a processor for a new candidate thread.

TRAC Logic for Determining if a Thread can be Run with a Starved Thread

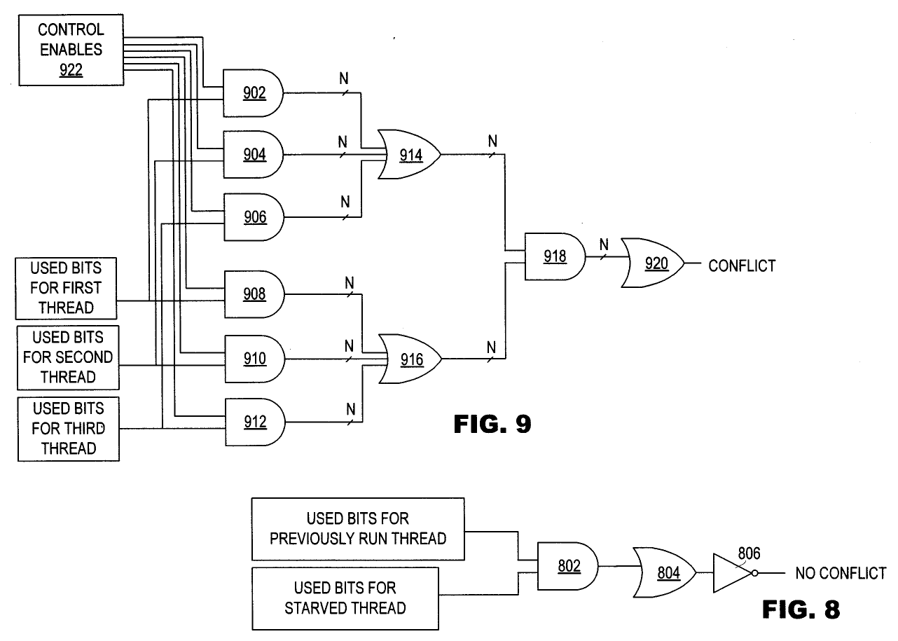

Referring now to FIG. 8, a portion of TRAC 202 conflict logic 512 is shown that determines if a given thread, such as a starved thread, which a processor has determined must run, has a peripheral resource conflict with another thread, such as a thread that is available to run with the starved thread, according to an embodiment of the present invention. As shown, each of N “used bits” of the starved thread and each of the corresponding N “used bits” of the other thread are inputted, respectively, to N two-input AND gates, represented by AND gate 802 in conflict logic 512. (Recall, as described herein above, corresponding “used bits” are associated with a given peripheral. If both bits are set to logical “1” this indicates both threads have used the same peripheral and, therefore, the two threads are considered to be in conflict.) N results out of AND 802 are input to N-input OR gate 804. If none of the N inputs are “1” then the output of OR gate 804 is “0”. In turn, the single output of OR gate 804 is input to inverter 806, so that if the output of OR gate 804 is “0” the output of inverter 806 is “1”, indicating no conflicts.

TRAC Logic for Determining if a Thread can be Run with Currently Running Threads

Referring now to FIG. 9, a portion of TRAC 202 conflict logic 512 is shown for determining if a specific set of threads has conflicts with a specific set of other threads, according to an embodiment of the present invention. This has application for determining if a set of candidate threads can be run with a set of threads that are already running, for example. Corresponding “used bits” of each thread in RUL 502 are input to pairs of respective AND gates in conflict logic 512. That is, in the instance illustrated, there are three threads, each having N used bits. Used bits for one thread are input to AND gates 902 and 908, used bits for another thread are input to AND gates 904 and 910, used bits for another are input to AND gates 906 and 912. (In similar fashion as in the illustration of FIG. 8, AND gates 902-912 and 912 shown in FIG. 9 each represent N two-input AND gates. Also, OR gates 914 and 916 each represent N three-input OR gates.) Control enable logic 922 in control logic 512 selects which of the AND gates 902-912 are enabled, by asserting a logical “1” to each selected AND gate.

Thus, for example, if processor 102 indicates to RUL 502 that the first thread is a candidate thread, and RUL 502 has determined the second and third threads are already running, control enable logic 922 enables AND gates 904 and 906 for the second and third threads, and enables AND gate 908 for the first thread. Then corresponding “used bits” of the candidate thread is compared with corresponding bits of both the second and third threads. That is, OR gate 914 outputs are asserted for each of the bits of the second or third threads that are asserted, indicating that one of the threads has used the corresponding peripheral. The output of OR gate 914 is sent to AND gate 918. Likewise, OR gate 916 outputs are asserted for each of the bits of the first thread that are asserted, and the outputs of OR 916 are sent to AND gate 918.

AND gate 918 compares the N outputs of OR gates 914 and 916 and if the outputs for the same bit are both logical “1” this indicates a peripheral conflict. The N outputs of AND gate 918 are fed to N-input OR gate 920. If no conflict is indicated for any of the “used bits” compared among threads, then none of the inputs to OR gate 920 are asserted, the output of OR gate 920 is thus not asserted, and no conflict is indicated for the compared threads.

Other Variations and General Remarks

It should be understood from the foregoing, that the invention is particularly advantageous since it reduces the chances of switching to threads that will have to wait for peripheral resources. That is, it provides a suitably collected and stored history of prior peripheral use, which is likely to indicate further peripheral use. Thread resource allocation logic advantageously cooperates with processors in selecting threads to run in response to this stored history. While this does not guarantee that threads will never encounter conflicts and stall, it reduces that likelihood. Furthermore, it may supplement other ways of managing thread usage, such as switching threads when they encounter conflicts and become stalled.

In various embodiments, system 200 (FIG. 2) takes a variety of forms, including a personal computer system, mainframe computer system, workstation, server, etc. That is, it should be understood that the term “computer system” is intended to encompass any device having a processor that executes instructions from a memory medium. System 200 may also include a keyboard, pointing device, e.g., mouse, nonvolatile memory, e.g., ROM, hard disk, floppy disk, CD-ROM, and DVD, and a display device.

Memory of system 200 stores program instructions (also known as a “software program”), which are executable by processors 102 and 104 to implement various embodiments of a method in accordance with the present invention. Various embodiments implement the one or more software programs in various ways, including procedure-based techniques, component-based techniques, and/or object-oriented techniques, among others. Specific examples include XML, C, C++ objects, Java and commercial class libraries. Those of ordinary skill in the art will appreciate that the hardware in FIG. 200 may vary depending on the implementation. For example, other peripheral devices may be used in addition to or in place of the hardware depicted in FIG. 2. The depicted example is not meant to imply architectural limitations with respect to the present invention.

The terms “logic”, “core”, “memory” and the like are used herein. It should be understood that these terms refer to circuitry that is part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The description of the present embodiment has been presented for purposes of illustration, but is not intended to be exhaustive or to limit the invention to the form disclosed. Many modifications and variations will be apparent to those of ordinary skill in the art. For example, it should be understood that while the present invention has been described in the context of a fully functioning data processing system, and while TRAC 202 has been described in terms of hardware-based logic, those of ordinary skill in the art will appreciate that the logic of TRAC 202 may be implemented by a processor application-specific integrated circuitry in which the processes of the present invention are capable of being distributed in the form of a computer readable medium of instructions. Such computer readable medium may have a variety of forms. The present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

Further, an embodiment of the invention is described herein in which thread allocation is based on history of the threads' use of peripheral devices (which may be viewed as a type of computing, i.e., processing, resource). However, it is within the spirit and scope of the invention to encompass an embodiment wherein thread allocation is based on history of the threads' use of a different type of computing resources.

Note also, an embodiment of the invention is described herein above in which threads are selected to run based on their histories indicating that the threads have used entirely different sets of threads. However, in an alternative, if the computer system of the present invention has multiple starved threads, the operating system can direct two (or even more) of the starved threads to run despite potential conflicts. That is, starved threads are selected to run concurrently, even though their respective histories indicate a potential conflict. In one such alternative, the history of all starved threads are compared as described herein above, and the ones that have the least number of potential conflicts are selected to run. In another, the threads that have less than a certain threshold number of potential conflicts are selected to run.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention.

Unless clearly and explicitly stated, the claims that follow are not intended to imply any particular sequence of actions. The inclusion of labels, such as a), b), c) etc., for portions of the claims does not, by itself, imply any particular sequence, but rather is merely to facilitate reference to the portions.

What is claimed is:

1. An apparatus comprising:
processors operable to concurrently execute respective instruction threads, wherein the system is operable to access shared processing resources; and
circuitry operable to communicate with the processors, wherein the circuitry includes:
memories for respective instruction threads;
first logic circuitry operable to generate and store history entries for the processing resources in respective ones of the memories for the respective instruction threads, wherein such a history entry indicates whether the processing resource for that entry has been used by the memory's corresponding one of the instruction threads; and
second logic circuitry operable to i) compare the history entries of first and second ones of the instruction threads, and ii) select the second instruction thread for executing if the comparing indicates history of processing resources used by the first thread has a certain difference relative to history of processing resources used by the second thread.

2. The apparatus of claim 1, wherein the first logic circuitry includes first sub-logic circuitry operable to generate and store if-used history entries in the memories, wherein the first sub-logic circuitry sets such an if-used entry to indicate use of a corresponding one of the processing resources by a corresponding one of the instruction threads and resets the if-used entry in response to the corresponding instruction thread exceeding a certain threshold of accumulated non-use of the corresponding processing resource.

3. The apparatus of claim 1, wherein the first logic circuitry includes second sub-logic circuitry operable to generate and store when-used history entries in the memories, the when-used history entries indicating when the respective processing resources were last used by the respective threads.

4. The apparatus of claim 3, wherein the second sub-logic circuitry includes cycle counter circuitry, the cycle counter circuitry being operable to control updating of the when-used entries responsive to cycles of a local bus for the processors.

5. The apparatus of claim 4, wherein the second sub-logic circuitry includes reset logic circuitry operable to signal the cycle counter circuitry to reset such a when-used entry responsive to a thread access to the peripheral resource.

6. The apparatus of claim 5, wherein the first logic circuitry includes first sub-logic circuitry operable to generate and store if-used history entries in the memories, wherein the first sub-logic circuitry sets such an if-used entry to indicate use of a corresponding one of the processing resources by a corresponding one of the instruction threads and resets the if-used entry in response to the corresponding instruction thread exceeding a certain threshold of accumulated non-use of the corresponding processing resource.

7. The apparatus of claim 6, wherein the setting of the if-used history entry by the first sub-logic circuitry is in response to the reset signal from the reset logic circuitry.

8. The apparatus of claim 3, wherein the second sub-logic circuitry has thread access counter logic circuitry and reset circuitry, the thread access counter logic circuitry being operable to i) initialize such a when-used entry to a first predetermined value in response to the reset circuitry signaling that a certain thread has accessed a peripheral, and ii) decrement the when-used entry responsive to the thread not accessing the peripheral.

9. The apparatus of claim 8, wherein the first logic circuitry includes first sub-logic circuitry operable to generate and store if-used history entries in the memories, wherein the first sub-logic circuitry sets such an if-used entry to indicate use of a corresponding one of the processing resources by a corresponding one of the instruction threads and resets the if-used entry in response to the corresponding instruction thread exceeding a certain threshold of accumulated non-use of the corresponding processing resource.

10. The apparatus of claim 9, wherein the thread access counter circuitry is operable to signal the first sub-logic to reset the if-used entry responsive to the when-used entry being decremented to a second predetermined value.

11. The apparatus of claim 1, wherein the processing resources include peripheral devices.

12. An apparatus comprising:
processors operable to concurrently execute respective instruction threads, wherein the system includes shared processing resources; and
circuitry operable to communicate with the processors, wherein the thread resource allocation core includes:
memories for respective instruction threads;
first logic operable to generate and store history entries in respective ones of the memories for the respective instruction threads and processing resources, wherein such a history entry indicates whether the processing resource for that entry has been used by the memory's corresponding one of the instruction threads; and
second logic operable to i) compare the history entries of first and second ones of the instruction threads, and ii) select the second instruction thread for executing if the comparing indicates the history of processing resources used by the first thread has a certain difference relative to the history of processing resources used by the second thread, wherein the first logic includes first sub-logic operable to generate and store if-used history entries in the memories, wherein the first sub-logic sets such an if-used entry to indicate use of a corresponding one of the processing resources by a corresponding one of the instruction threads and resets the if-used entry in response to the corresponding instruction thread exceeding a certain threshold of accumulated non-use of the corresponding processing resource, and wherein the first logic includes second sub-logic operable to generate and store when-used history entries in the memories, the when-used history entries indicating when the respective processing resources were last used by the respective threads.

13. A method in a multiprocessor system, the method comprising:
a) detecting instruction threads executed by the system;
b) storing thread entries in a first memory of the system, wherein the thread entries indicate the executed instruction threads;
c) detecting uses of processing resources by the respective instruction threads;
d) storing, in a second memory of the system, history entries for the executed instruction threads, wherein such history entries indicate whether respective processing resources have been used by respective ones of the instruction threads;
e) comparing the history entries of first and second ones of the instruction threads; and
f) selecting the second instruction thread for executing if the comparing in e) indicates history of processing resources used by the first thread has a certain difference relative to history of processing resources used by the second thread.

14. The method of claim 13, wherein the certain difference in f) includes the history of processing resources used by the first thread being entirely different than the history of processing resources used by the second thread.

15. The method of claim 13 comprising:
g) changing history entries in response to an accumulation of use and non-use of the processing resources.

16. The method of claim 15, wherein g) includes
setting such a processing resource's history entry to indicate use; and
resetting the entry in response to the history entry's corresponding instruction thread exceeding a certain threshold of accumulated non-use of the processing resource.

17. The method of claim 13, wherein in e) the first thread is running and a processor of the system has selected the second thread as a candidate to run with the first thread.

18. The method of claim 13, wherein in e) one of the system processors has selected the first thread to run and the second thread is already running.

19. The method of claim 13, wherein the processing resources include peripheral devices of the system.

20. The method of claim 13, wherein the processing resources include peripheral devices of the system, wherein in e) the first thread is running and a processor of the system has selected the second thread as a candidate to run with the first thread, wherein the certain difference in f) includes the history of processing resources used by the first thread being entirely different than the history of processing resources used by the second thread, and wherein the method includes:
g) changing history entries in response to an accumulation of use and non-use of the processing resources, including:
setting such a processing resource's history entry to indicate use; and
resetting the entry in response to the history entry's corresponding instruction thread exceeding a certain threshold of accumulated non-use of the processing resource.
